(19) United States
(12) Patent Application Publication
(10) Pub. No.: US 2026/0210342 A1
(43) Pub. Date: Jul. 23, 2026

(54) COMPACT OPPOSED PUMP

(71) Applicant: Cummins-Scania HPCR System, LLC, Columbus, IN (US)

(72) Inventors: Eric A. Benham, Columbus, IN (US); Mustafa Utku Unal, Sodertalje (SE); Donald J. Benson, Columbus, IN (US); Samuel David Griffith Magnuson, Louisville, KY (US); Benjamin Scott Myser, Batesville, IN (US)

(21) Appl. No.: 19/567,884

(22) Filed: Mar. 16, 2026

Related U.S. Application Data
(63) Continuation of application No. 17/910,570, filed on Mar. 11, 2020, now Pat. No. 12,631,164.

(51) Int. Cl. F04B 1/0421; F02M 43/00; F02M 43/02; F04B 1/0413; F04B 1/0452; F04B 1/0536; F04B 7/00; F04B 9/04; F04B 53/10

(52) U.S. Cl. CPC F04B 1/0421; F04B 1/0413; F04B 1/0452; F04B 1/0536; F04B 7/0076; F04B 9/04; F04B 53/10; F02M 43/00; F02M 43/02

(57) ABSTRACT

The present disclosure provides a high-pressure fuel pump having barrel sets comprising offset, opposing barrel units within the same plane and having plungers disposed therein. The high-pressure fuel pump further includes a camshaft having at least one offset lobe and a cam ring encircling the lobe and in contact with the plungers, which translate the rotational movement of the camshaft to longitudinal movement of the plungers, controlling inflow, compression, and outflow of fuel within the pump.

### TECHNICAL FIELD OF THE PRESENT DISCLOSURE

The present invention generally relates to a compact eccentric opposed pump, and more particularly, to an opposed pump having offset pumping elements to lighten torque load on a camshaft.

### BACKGROUND OF THE PRESENT DISCLOSURE

High-pressure fuel pumps are common components of fuel systems for internal combustion engines, especially in diesel engines. High-pressure pumps often receive fuel from a low-pressure system before entering a common rail and ultimately the engine via fuel injectors. The fuel is then compressed and exits the pump. Each of these actions are initiated through movement of a plunger controlled by rotation of a camshaft. For example, in high-pressure pumps, fuel is drawn through a fuel inlet as the plunger is lowered relative to a respective barrel containing the plunger. When the plunger then moves upwards, the fuel is compressed, increasing the pressure of the fuel. The fuel then exits the pump to enter the common rail or another fuel system component.

Typically, fuel pumps are created by drilling bores into a monolithic block to create pumping units in a linear arrangement, which has cost and manufacturing challenges. Significant cost savings and replacement ease can be achieved using modular barrel units which can be used across a number of fuel pump types, as well as by using light weight, non-load-bearing housing. Furthermore, a space-saving fuel pump may be more easily used across engine sizes and types.

### SUMMARY OF THE DISCLOSURE

The present disclosure provides a high-pressure fuel pump having barrel sets comprising offset, opposing barrel units within the same plane and having plungers disposed therein. The high-pressure fuel pump further includes a camshaft having at least one offset lobe and a cam ring encircling the lobe and in contact with the plungers, which translate the rotational movement of the camshaft to longitudinal movement of the plungers, controlling inflow, compression, and outflow of fuel within the pump.

In an exemplary embodiment of the present disclosure, a high-pressure pump is disclosed. The high-pressure pump comprises: a housing; a camshaft assembly disposed through the housing and having an offset lobe and a cam ring encircling the offset lobe; a first barrel unit disposed on a first side of the housing, the first barrel unit having a first axis; and a second barrel unit disposed on a second side of the housing opposite from the first side, wherein the first barrel unit and the second barrel unit are positioned within a first common plane. The second barrel unit has a second axis offset from the first axis.

The high-pressure pump may further comprise a first plunger disposed within the first barrel unit corresponding with the first axis and a second plunger disposed within the second barrel unit corresponding with the second axis, the first plunger and the second plunger in contact with the cam ring of the camshaft assembly. The high-pressure pump may further comprise a first spring positioned around the first plunger configured to bias the first plunger toward the camshaft assembly and a second spring positioned around the second plunger configured to bias the second plunger toward the camshaft assembly.

The high-pressure pump may further comprise a third barrel unit disposed on a third side of the housing, the third barrel unit having a third axis, and a fourth barrel unit disposed on a fourth side of the housing opposite from the third side, the fourth barrel unit having a fourth axis, wherein the third barrel unit and the fourth barrel unit are positioned within a second common plane and the third axis is offset form the fourth axis. The first barrel unit, the second barrel unit, the third barrel unit, and the fourth barrel unit may be equally disposed around a perimeter of the housing.

In another exemplary embodiment of the present disclosure, a high-pressure pump is disclosed. The high-pressure pump comprises: a housing; a camshaft assembly disposed through the housing, the camshaft having a centerline point, an offset lobe, and a cam ring encircling the offset lobe; a first barrel unit disposed on a first side of the housing, the first barrel unit having a first axis; and a second barrel unit disposed on a second side of the housing opposite from the first side, the second barrel unit having a second axis, the first axis and the second axis offset form the centerline point of the camshaft assembly.

The first axis and the second axis may be offset from each other. The first barrel unit and the second barrel unit may be modular barrel units, and the pump may further comprise any one of a passive inlet metering valve, an active inlet metering valve, and a hybrid active inlet metering valve.

The high-pressure pump may further comprise a third barrel unit disposed on a third side of the housing, the third barrel unit having a third axis; and a fourth barrel unit disposed on a fourth side of the housing opposite from the third side, the fourth barrel unit having a fourth axis. The third axis and the fourth axis may be offset from the centerline point of the camshaft assembly. The first barrel unit and the second barrel unit may be in a first common plane and the third barrel unit and the second barrel unit may be in a second common plane.

In yet another exemplary embodiment of the present disclosure, a high-pressure pump is disclosed. The high-pressure pump comprises: a housing; a camshaft assembly disposed through the housing, the camshaft assembly having an offset lobe and a cam ring encircling the offset lobe; a first modular barrel unit coupled to a first side of the housing; and any one of a passive inlet metering valve, an active inlet metering valve, and a hybrid active inlet metering valve.

The high-pressure pump may further comprise a second modular barrel unit coupled to the housing on a second side of the housing opposite from the first side, wherein the first modular barrel unit and the second modular barrel unit are positioned within a first common plane. The high-pressure pump may further comprise a third modular barrel unit coupled to the housing on a third side of the housing and a fourth modular barrel unit coupled to the housing on a fourth side of the housing opposite from the third side, the third modular barrel unit and the second modular barrel unit positioned within a second common plane.

The high-pressure pump may further comprise a plunger disposed within the modular barrel unit and in contact with the camshaft, wherein the plunger contacts the cam ring of the camshaft assembly at a point offset from a centerline point of the camshaft.

In yet another exemplary embodiment of the present disclosure, a modular barrel unit is disclosed. The modular barrel unit comprises a module body defining: a first opening configured to receive an inlet valve of at least one of a passive inlet metering valve, an active inlet metering valve, and a hybrid active inlet metering valve; a second opening configured to receive a plunger; a channel configured to house an outlet check valve; and a modular pathway configured to align with at least one fuel pathway of a high-pressure fuel pump. The modular barrel unit further comprises a plunger disposed within the second opening and an outlet check valve disposed within the channel.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1A is a perspective view of a high-pressure opposed unit pump having a passive inlet metering valve compared to a high-pressure opposed unit pump having an active inlet metering valve;

FIG. 1B is a front side view comparing the high-pressure opposed unit pump having a passive inlet metering valve of FIG. 1A with the high-pressure opposed unit pump having an active inlet metering valve of FIG. 1A;

FIC. 1C is a back side view comparing the high-pressure opposed unit pump having a passive inlet metering valve of FIG. 1A with the high-pressure opposed unit pump having an active inlet metering valve of FIG. 1A;

FIG. 2 is a cross-sectional view of a high-pressure opposed unit pump, showing the interior make-up of the pump and the barrel units of the pump;

FIG. 3A is a front view of a high-pressure opposed unit pump, wherein the pump includes two modular barrel units;

FIG. 3B is a front view of a high-pressure opposed unit pump, wherein the pump includes four modular barrel units;

FIG. 3C is a perspective view of a high-pressure pump, wherein the pump includes one modular barrel unit;

FIG. 4A is a cross-sectional view of a high-pressure opposed unit pump having an active inlet metering valve;

FIG. 4B is a cross-sectional view of a high-pressure opposed unit pump having a hybrid active inlet metering valve; and

FIG. 4C is a cross-sectional view of a high-pressure opposed unit pump having a passive inlet metering valve.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

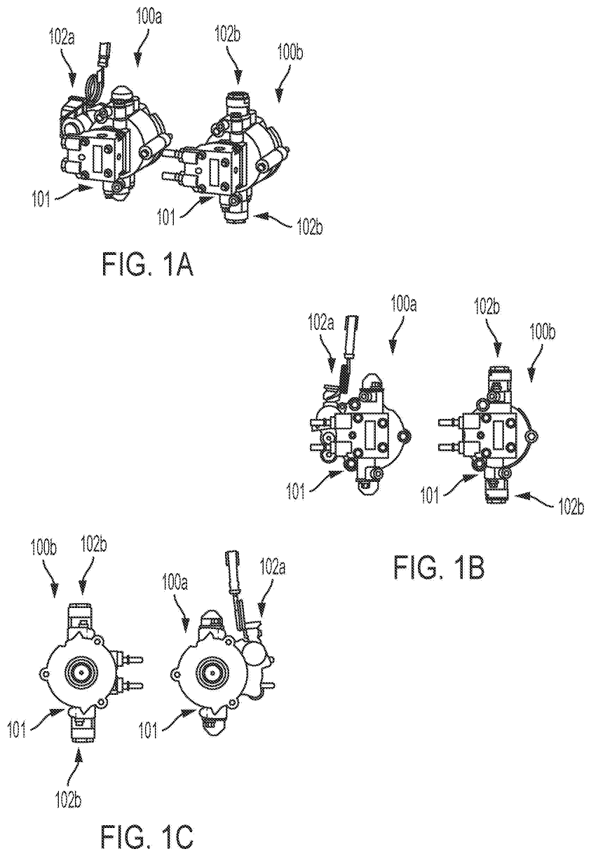

Referring initially to FIGS. 1A-1C, high pressure pumps 100a and 100b, illustratively high-pressure fuel pumps for internal combustion engines, are disclosed. The high-pressure pump 100a is configured to include a passive inlet metering valve system 102a, while the high-pressure pump 100b is configured to include an active inlet metering system 102b. The remaining components of the high-pressure pumps 100a and 100b are consistent between the embodiments and will therefore be referred to with consistent reference numbers. Each of the high-pressure pumps 100 further include a modular barrel unit and camshaft arrangement 101 as discussed further herein.

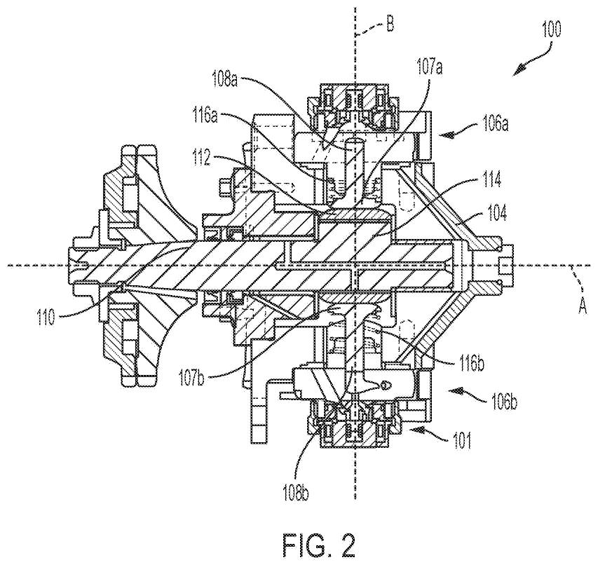

For example, referring to FIG. 2, a cross-section of the high-pressure pump 100 discloses the components of the modular barrel and camshaft arrangement 101, including a housing 104 and at least a first modular barrel unit 106a and a second modular barrel unit 106b positioned opposite of the housing from the first modular barrel unit 106a. In an illustrative embodiment, the housing 104 is comprised of a lightweight material, such as aluminum. In other embodiments, the housing 104 may be comprised of other materials, including polymers, metallic composites, and other metals. Each of the modular barrel units 106 include a plunger 108a and 108b disposed within the respective barrel 106a or 106b.

A camshaft assembly 110 is disposed through the housing 104 and is configured to rotate about an axis A; the camshaft includes at least one offset lobe 114 discussed further herein and a cam ring 112 encircling the at least one offset lobe 114. The cam ring 112 contacts a foot 107 of each of the plungers 108 either directly or indirectly via a shim or puck. A spring 116a or 116b may be included within the respective barrel 106 and disposed around the respective plunger 108 to bias the plungers 108 toward the camshaft assembly 110. As the camshaft assembly 110 rotates, the feet 107 of the respective plungers 108 follow the movement of the cam ring 112 and the lobe 114 to transfer the rotational movement of the camshaft to longitudinally movement of the plungers 108 within their respective barrels 106 along axis B, which may be positioned generally perpendicular to axis A. In other words, the axis B corresponds with both the barrel 106 and its respective plunger 108. Typically, center axes of the barrels discussed herein correspond with the center axes of the corresponding plungers.

The fuel is metered via active or passive inlet metering valves to control the inlet flow of fuel from a source such as a low pressure pump (not shown). The movement of each of the plunger 108 within each respective barrel 106 is translated to compression of the fuel within the pump 100 and outflow of the compressed fuel to the remainder of the fuel system of the engine (not shown). In an ideal embodiment discussed further herein, each barrel 106 has a unique axis offset from a unique axis of another barrel 106, each of the axes positioned generally perpendicular to axis A. In other words, as the plungers 108 follow the movement of the camshaft assembly 110, the bias from the springs 116 may be overcome to allow the plungers 108 to move within their respective barrels 106. As the plunger 108 moves in a direction generally away from the camshaft assembly 110, it interacts with the respective active or passive inlet metering valve system 102 to control the pumping of fuel for engine operation.

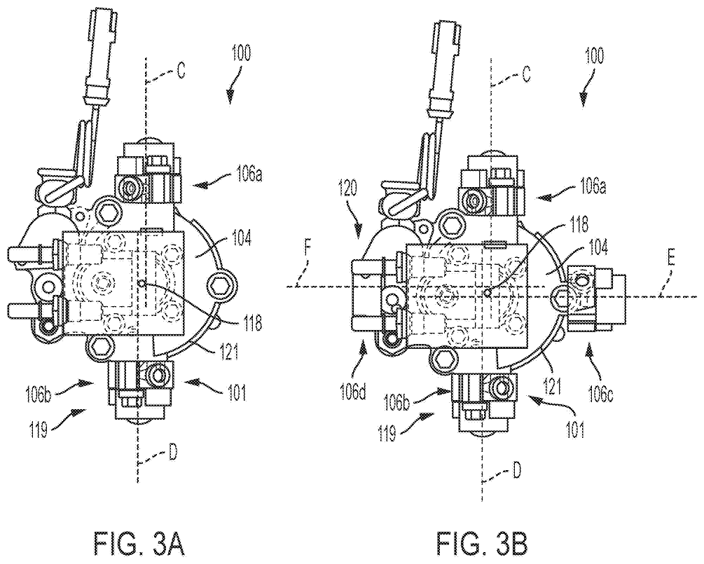

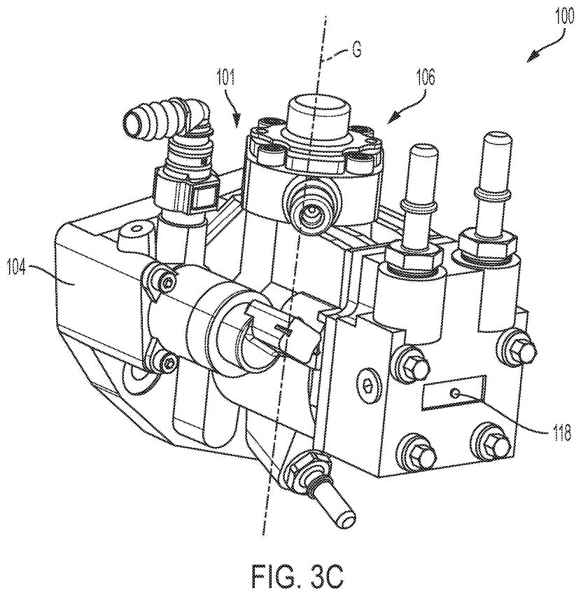

Now referring to FIG. 3A an end view of the high-pressure pump 100 is shown, disclosing the offset axes C and D of barrels 106a and 106b of the modular barrel unit and camshaft arrangement 101 respectively. The axes C and D are not only offset from each other but are further offset from a centerline point of the camshaft assembly 110, the centerline point generally consistent with axis A (FIG. 2), as indicated by point 118. Ensuring that the barrels 106a and 106b are offset from the camshaft centerline point 118 reduces the plunger to barrel side load force magnitudes, thereby reducing scuffing power loss, plunger and barrel wear, and stress placed upon the foot 107 of the respective plunger 108 (FIG. 2) and further reduces stress on other components of the pump 100. FIG. 3B discloses an additional embodiment of the high pressure pump 100, wherein the pump 100 includes four barrels 106a, 106b, 106c, and 106d. Notably, each barrel 106 includes a unique offset axis, wherein axis C corresponds with barrel 106a, axis D corresponds with barrel 106b, axis E corresponds with barrel 106c, and axis F corresponds with barrel 106d. Each of the axes C, D, E, and F are offset from the camshaft centerline point 118 as described above in relation to FIG. 3A for the same advantages described above in relation to FIG. 3A.

Notably, the high-pressure pump 100 of FIG. 3B includes two sets of barrels 106. Barrel set 119 comprises barrels 106a and 106b and is positioned in a plane parallel to and including axes C and D. Barrel set 120 comprises barrels 106c and 106d and is positioned in a plane parallel to and including axes E and F. Further embodiments may comprise additional barrel sets, wherein each barrel set preferably includes two barrel units within a single plane to minimize torque loading on the camshaft assembly 110 (FIG. 2). Barrel units must be separated evenly around a perimeter 121 of the housing 104 of the pump 100 in a uniform manner to create a uniform load on the housing 104 and the camshaft assembly 110 (FIG. 2) but may otherwise be positioned in as many planes as feasible around the pump 100.

Now referring to FIG. 3C, a high-pressure pump 100 may otherwise include only one barrel unit 106 to reduce cost and size for lower power engines. All of the components for single barrel pump 100 are the same as for the two barrel pump 100 of FIG. 3B, without the two barrel arrangement. The single barrel pump 100 reduces cost and is also provides for a smaller overall package to fit within smaller locations on smaller engines. The single barrel pump 100 operates the same as the other pumps described herein, wherein the barrel 106 is offset from a centerline 118 of the camshaft assembly 110 (FIG. 2) along axis G.

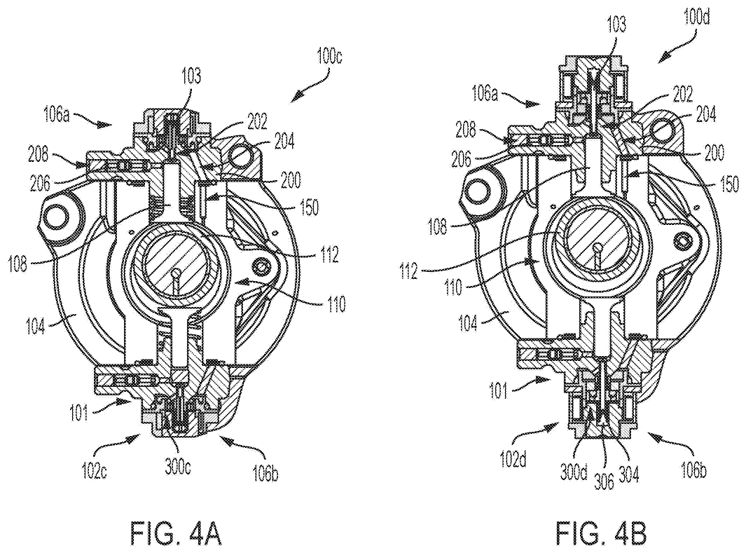

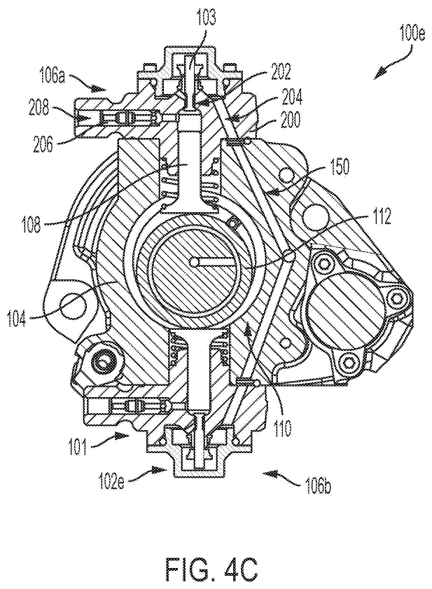

The ability of the modular barrel unit and camshaft arrangement 101 to be utilized among various types of pumps 100 is mentioned above in relation to FIGS. 1A-1C. Such modularity is further illustrated in FIGS. 4A-4C. FIG. 4A provides the cross-section of a high-pressure pump 100c having an active inlet metering valve 102c. FIG. 4B provides the cross-section of a high-pressure pump 100d having a hybrid active inlet metering valve 102d. The high-pressure pump 100d having the hybrid active inlet metering valve 102d achieves the same function as the active inlet metering valve 102c, however the hybrid active inlet metering valve 102d is capable of using existing components.

For example, the active inlet metering valve 102c includes an armature 300c that is disposed directly on a barrel post 302 of the modular barrel unit 106. However, for the hybrid active inlet metering valve 102d, the armature 300d, spring 304, spring retainer 306 and other components of the valve 102d are reused, which results in a taller overall structure for the high-pressure pump 100d relative to the high-pressure pump 100c having the active inlet metering valve 102c, as can be seen by comparing FIG. 4A with FIG. 4B. Additionally, the hybrid active inlet metering valve pump 100d allows common barrel architecture between inlet metering valve and active inlet metering valve embodiments while maximizing reuse of existing active inlet metering valve components.

FIG. 4C provides the cross-section of a high pressure pump 100e having a passive inlet metering valve 102e. As shown by the cross-section of each of the high pressure opposed pump, the modular barrel unit and camshaft arrangement 101 is consistent across each of the high-pressure pumps 100. In other words, the modular barrel unit and camshaft arrangement 101 is capable of being applied across different types of high-pressure pumps to provide the benefits discussed above.

As illustrated in FIGS. 4A-4C, the modular barrel unit 106 includes a module body 200 with an opening 202 for the inlet valve 103 of the respective metering valve of the high-pressure pump 100. The plunger 108 is disposed at least partially within the module body 200 so that it operatively communicates with the cam ring 112 of the camshaft assembly 110 and the inlet valve 103. A pathway 204 is included through the module body 200 to align with fuel pathways 150 of the housing 104 of the high-pressure pump 100 for effective operation. The modular barrel unit 106 further includes an outlet check valve 206 disposed within a channel 208. The outlet check valve 206 allows the outflow of pressurized fluid during operation to be sent to a common rail of the engine or otherwise provided to the engine for operation without facilitating a leak from the high-pressure pump 100. Such modularity allows the modular barrel unit 106 itself to be replaced in the event of component failure rather than the entire high-pressure pump 100. The modularity of the modular barrel unit 106 further allows more convenient field service by providing a uniform unit across a number of types of high-pressure pumps and engines.

While the invention has been described by reference to various specific embodiments it should be understood that numerous changes may be made within the spirit and scope of the inventive concepts described, accordingly, it is intended that the invention not be limited to the described embodiments but will have full scope defined by the language of the following claims.

1-15. (canceled)

16. A high-pressure fuel pump comprising:
a housing;
a camshaft assembly disposed through the housing, the camshaft assembly having an offset lobe and a cam ring encircling the offset lobe;
a first modular barrel unit coupled to a first side of the housing; and
any one of a passive inlet metering valve, an active inlet metering valve, and a hybrid active inlet metering valve coupled to the housing, wherein the first modular barrel unit includes:
a module body defining:
a first opening configured to receive an inlet valve,
a second opening configured to receive a plunger,
a channel configured to house an outlet check valve, and
a modular pathway configured to align with at least one fuel pathway of the housing of the high pressure pump;
a plunger disposed in the second opening; and
an outlet check valve disposed within the channel.

17. The high-pressure fuel pump of claim 16, comprising:
a second modular barrel unit disposed on a second side of the housing opposite from the first side; wherein the first modular barrel unit and the second modular barrel unit are positioned within a first common plane, the second modular barrel unit having a second center axis offset from a first center axis of the first modular barrel unit.

18. The high-pressure fuel pump of claim 17, wherein the plunger comprises a first plunger disposed within the first barrel unit corresponding with the first center axis and a second plunger disposed within the second barrel unit corresponding with the second center axis, wherein the first plunger and the second plunger are in contact with the cam ring of the camshaft assembly.

19. The high-pressure fuel pump of claim 18, further comprising a first spring positioned around the first plunger within the first barrel unit, the first spring configured to bias the first plunger toward the camshaft assembly, and a second spring positioned around the second plunger within the second barrel unit, the second spring configured to bias the second plunger toward the camshaft assembly.

20. The high-pressure fuel pump of claim 17, further comprising:
a third barrel unit disposed on a third side of the housing, the third barrel unit having a third center axis; and
a fourth barrel unit disposed on a fourth side of the housing opposite from the third side, the fourth barrel unit having a fourth center axis;
wherein the third barrel unit and the fourth barrel unit are positioned within a second common plane and the third center axis is offset from the fourth center axis.

21. The high-pressure fuel pump of claim 20, wherein the first barrel unit, the second barrel unit, the third barrel unit, and the fourth barrel unit are equally disposed around a perimeter of the housing.

22. The high-pressure fuel pump of claim 17, wherein:
the camshaft assembly has a centerline point defined by a central longitudinal axis of the camshaft assembly around which the camshaft assembly is configured to rotate and the first center axis and the second center axis are offset from the centerline point of the camshaft assembly.

23. The high-pressure fuel pump of claim 22, wherein the first center axis and the second center axis are offset from each other.

24. The high-pressure fuel pump of claim 22, further comprising:
a third barrel unit disposed on a third side of the housing, the third barrel unit having a third center axis; and
a fourth barrel unit disposed on a fourth side of the housing opposite from the third side, the fourth barrel unit having a fourth center axis;
wherein the third center axis and the fourth center axis are offset from the centerline point of the camshaft assembly.

25. The high-pressure fuel pump of claim 24, wherein the first barrel unit and the second barrel unit are in a first common plane and the third barrel unit and the fourth barrel unit are in a second common plane.

26. The high-pressure fuel pump of claim 16, further comprising a second modular barrel unit coupled to the housing on a second side of the housing opposite from the first side, the first modular barrel unit and the second modular barrel unit are positioned within a first common plane.

27. The high-pressure fuel pump of claim 26, further comprising a third modular barrel unit coupled to the housing on a third side of the housing and a fourth modular barrel unit coupled to the housing on a fourth side of the housing opposite from the third side, the third modular barrel unit and the fourth second modular barrel unit positioned within a second common plane.

28. The high-pressure fuel pump of claim 26, wherein the plunger includes plungers disposed within each of the first modular barrel unit and the second modular barrel unit in contact with the camshaft assembly, wherein the plungers contact the cam ring of the camshaft assembly at a point offset from the centerline point of the camshaft assembly.

29. A modular barrel unit comprising:
a module body defining:
a first opening configured to receive an inlet valve of at least one of a passive inlet metering valve, an active inlet metering valve, and a hybrid active inlet metering valve;
a second opening configured to receive a plunger;
a channel configured to house an outlet check valve; and
a modular pathway configured to align with at least one fuel pathway of a high-pressure fuel pump; a plunger disposed within the second opening; and an outlet check valve disposed within the channel.
